(19) United States
(12) Patent Application Publication
(10) Pub. No.: US 2021/0152367 A1
(43) Pub. Date: May 20, 2021

(54) MONITORING A CONDITION OF ELECTRONIC DEVICES

(71) Applicant: International Business Machines Corporation, Armonk, NY (US)

(72) Inventors: Murugesan Boopathy, Vellore (IN); Manikandan Padmanaban, Bangalore (IN); Kalyan Dasgupta, Bengaluru (IN); Ranjani J, Nagercoil (IN); Siddappa Mirji, Bengaluru (IN)

(21) Appl. No.: 16/687,728

(22) Filed: Nov. 19, 2019

(51) Int. Cl. H04L 9/32; G01R 19/25

(52) U.S. Cl. CPC H04L 9/3247; G01R 19/2513

(57) ABSTRACT

A method includes obtaining device data corresponding to a set of electronic devices, the set including a first, second, and third electronic device. The method includes grouping the set of electronic devices into a first cluster and a second cluster, wherein the first cluster includes the first and second electronic devices, and the second cluster includes the third electronic device. The method includes obtaining first signature data comprising one or more first electrical parameters of the first electronic device and second signature data comprising one or more second electrical parameters of the second electronic device. The method includes determining that a first electrical parameter of the first signature data matches a second electrical parameter of the second signature data. The method includes regrouping the set of electronic devices such that the first cluster includes the first electronic device and the second cluster includes the second and third electronic devices.

### BACKGROUND

The present disclosure relates to electronic devices, and more specifically, to monitoring a condition of electronic devices.

An electronic device, such as a household appliance, can include its own sensor that can monitor an operating condition of the electronic device. An electrical circuit can include a set of electronic devices and a sensor that can monitor electrical parameters of the electrical circuit.

### SUMMARY

According to embodiments of the present disclosure, a method can include obtaining device data corresponding to a set of electronic devices. The set of electronic devices can include a first electronic device, a second electronic device, and a third electronic device. The method can further include grouping, based on the device data, the set of electronic devices into a first cluster and a second cluster. The first cluster can include both the first electronic device and the second electronic device. The second cluster can include the third electronic device. The method can further include obtaining first signature data comprising one or more first electrical parameters of the first electronic device. The method can further include obtaining second signature data comprising one or more second electrical parameters of the second electronic device. The method can further include making a first determination, based on comparing the first signature data to the second signature data, that a first electrical parameter of the first signature data matches a second electrical parameter of the second signature data. The method can further include regrouping, based on the first determination, the set of electronic devices such that the first cluster includes the first electronic device and the second cluster includes both the second electronic device and the third electronic device. The method can further include assigning a first sensor to the first cluster. The method can further include assigning a second sensor to the second cluster.

A system and a computer program product corresponding to the above method are also included herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example computing environment that includes a cluster of electronic devices, a corresponding sensor, a computing device, a server, a condition monitor, and a network, in accordance with embodiments of the present disclosure.

FIG. 2 depicts a flowchart of an example method for determining clusters of electronic devices and monitoring one or more conditions of a set of electronic devices.

FIG. 3 depicts the representative major components of a computer system that can be used in accordance with embodiments of the present disclosure.

FIG. 4 depicts a cloud computing environment according to an embodiment of the present disclosure.

FIG. 5 depicts abstraction model layers according to an embodiment of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to electronic devices; more particular aspects relate to monitoring a condition of electronic devices. While the present disclosure is not necessarily limited to such applications, various aspects of the disclosure may be appreciated through a discussion of various examples using this context.

An electronic device, such as a television, washing machine, or air conditioning unit can have an individual monitoring configuration in which the electronic device has a respective sensor to monitor the electronic device's performance. Such monitoring can indicate whether the electronic device has a standard operating condition (e.g., the electronic device functions in accordance with its design specifications without fault or defect) or a defective operating condition (e.g., the electronic device is inoperable or the electronic device functions inconsistently with its design specifications, such as with a fault or defect). Such an individual monitoring configuration can include at least as many sensors as electronic devices to perform the monitoring. In some cases, a set of electronic devices can have a monitoring configuration in which the set of electronic devices is included on an electrical circuit, and a sensor can monitor the performance of all of the electronic devices on the electrical circuit. In this monitoring configuration, the sensor may not be able to distinguish the electrical parameters of the monitored electronic devices. Challenges to distinguishing the electrical parameters can occur when the electrical signals generated by the monitored electronic devices are substantially similar or identical, cancel each other, or otherwise distort the data measured by the sensor.

To address these and other challenges, embodiments of the present disclosure include a condition monitor that can group a set of electronic devices into subsets (i.e., clusters) based, at least in part, on device data (e.g., characteristics of each electronic device) and signature data (e.g., electrical parameters that correspond to an operating condition of each electronic device). By such grouping of the set of electronic devices, the condition monitor can determine a minimum number of sensors that can monitor distinguishable electrical parameters of the set of electronic devices. Accordingly, the embodiments of the present disclosure can facilitate accurate determinations of one or more operating conditions of each of the electronic devices. In some embodiments, the condition monitor can determine whether an electronic device has a standard operating condition or a defective operating condition and transmit a corresponding notification to a user.

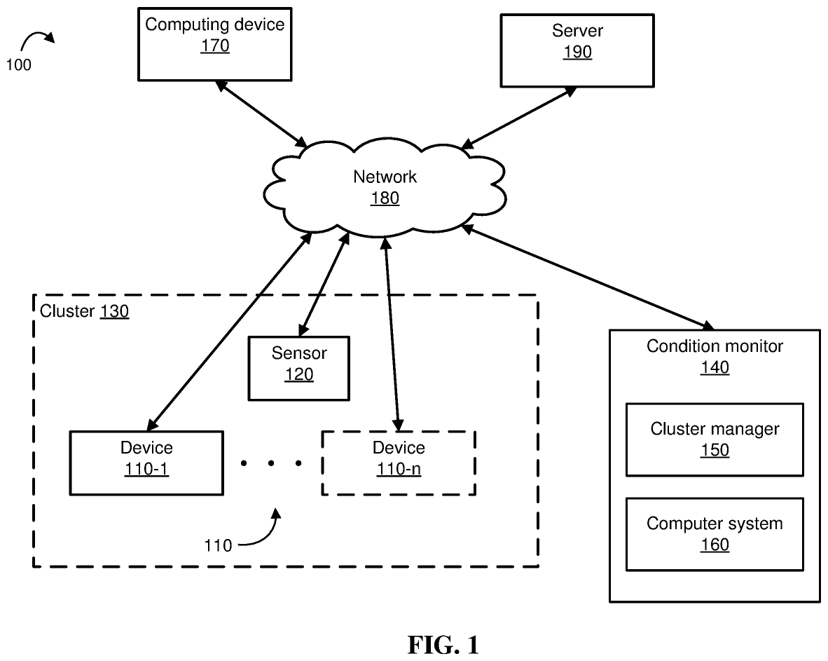

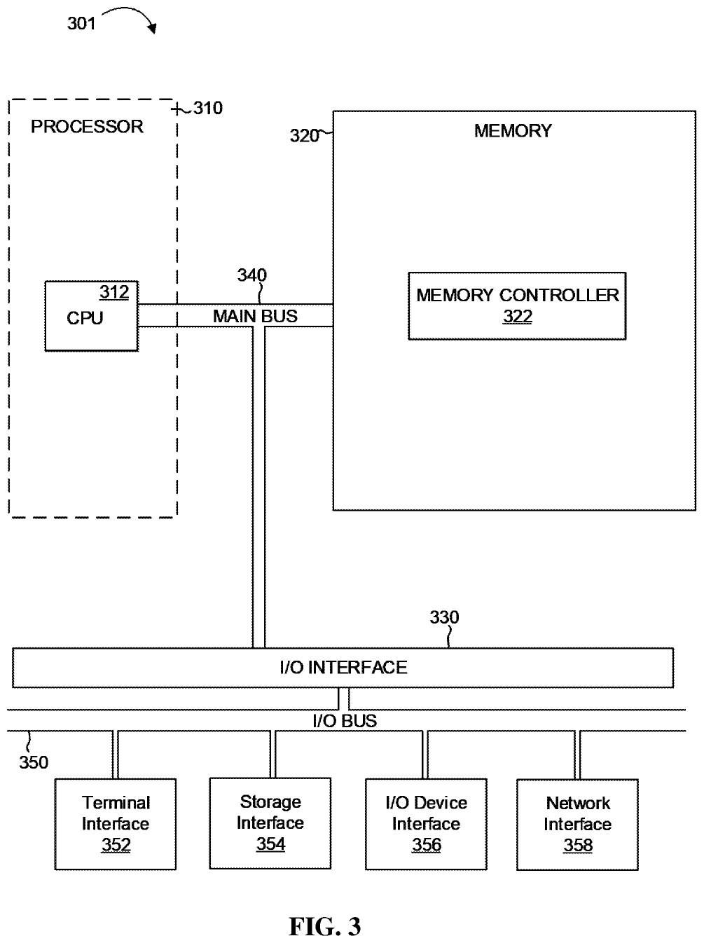

Turning to the figures, FIG. 1 illustrates an example computing environment 100 that includes at least one of each of a cluster 130 having a sensor 120 and a set of electronic devices 110, a condition monitor 140, a server 190, and a computing device 170. In some embodiments, the sensor 120, set of electronic devices 110, condition monitor 140, server 190, and computing device 170 can exchange data with one another through a network 180. The set of electronic devices 110 can include one or more electronic devices. For example, in some embodiments, the set of electronic devices 110 can include n electronic devices, where n is an integer greater than zero. For example, n=1 in embodiments in which the set of electronic devices 110 includes only a first electronic device 110-1; n=2 in embodiments in which the set of electronic devices 110 includes two electronic devices (a first electronic device 110-1 and a second electronic device 110-2); and so on. In some embodiments, one or more of the server 190, the computing device 170, the network 180, the set of electronic devices 110, and the condition monitor 140 can include a computer system, such as the computer system 301 described with respect to FIG. 3.

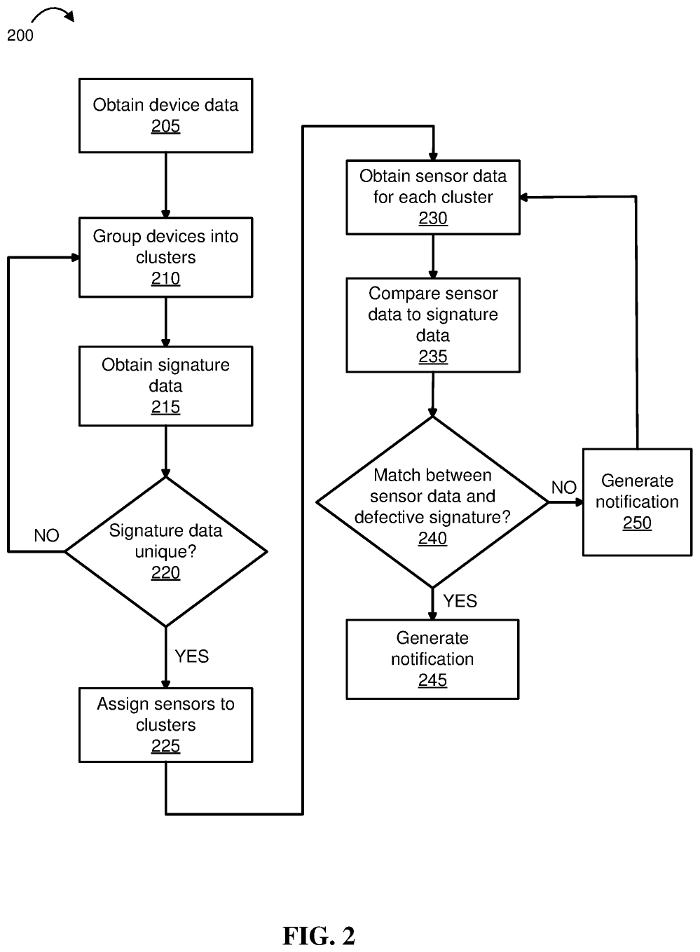

Referring back to FIG. 1, the condition monitor 140 can include one or more processors configured to perform one or more of the method steps described with respect to FIG. 2. In some embodiments, the condition monitor 140 can include a cluster manager 150 and a computer system 160. In some embodiments, the cluster manager 150 can include a processor configured to perform one or more of the method steps 205-225 described with respect to FIG. 2. In some embodiments, the computer system 160 can include a processor configured to perform one or more of the method steps 230-250 described with respect to FIG. 2. In some embodiments, the computer system 160 can be identical or substantially similar to the computer system 301 described with respect to FIG. 3. Referring back to FIG. 1, in some embodiments, the condition monitor 140 can be a discrete computer system located remotely from the set of electronic devices 110, the sensor 120, the server 190, and the computing device 170. In some embodiments, the condition monitor 140 can be integrated into the server 190 and/or the computing device 170. In some embodiments, the condition monitor 140 can include a display configured to present graphical and/or alphanumeric notifications, such as a notification corresponding to an operating condition of an electronic device.

In some embodiments, the condition monitor 140 can define one or more clusters 130. A cluster 130 can be a designation given to a set of electronic devices 110 by the condition monitor 140. In some embodiments, a cluster 130 can include a sensor 120 that is configured to measure electrical parameters of the set of electronic devices 110 in the cluster 130. In such embodiments, the condition monitor 140 can obtain the electrical parameters of the set of electronic devices 110 via network 180. In some embodiments, the set of electronic devices 110 can include electrically powered devices and/or appliances, such as air-conditioning units, refrigerators, dishwashers, washing machines, microwave ovens, electric water heaters, lamps, fans, computers, televisions, and the like.

In some embodiments, the computing device 170 can include a mobile phone, a tablet, a computer, and the like. In some embodiments, the computing device 170 can receive notifications generated by the condition monitor 140. In some embodiments, the server 190 can be located remotely from the set of electronic devices 110, the sensor 120, the condition monitor 140, and the computing device 170. In some embodiments, one or more of the server 190, the computing device 170, and the condition monitor 140 can include memory configured to store data, such as signature data.

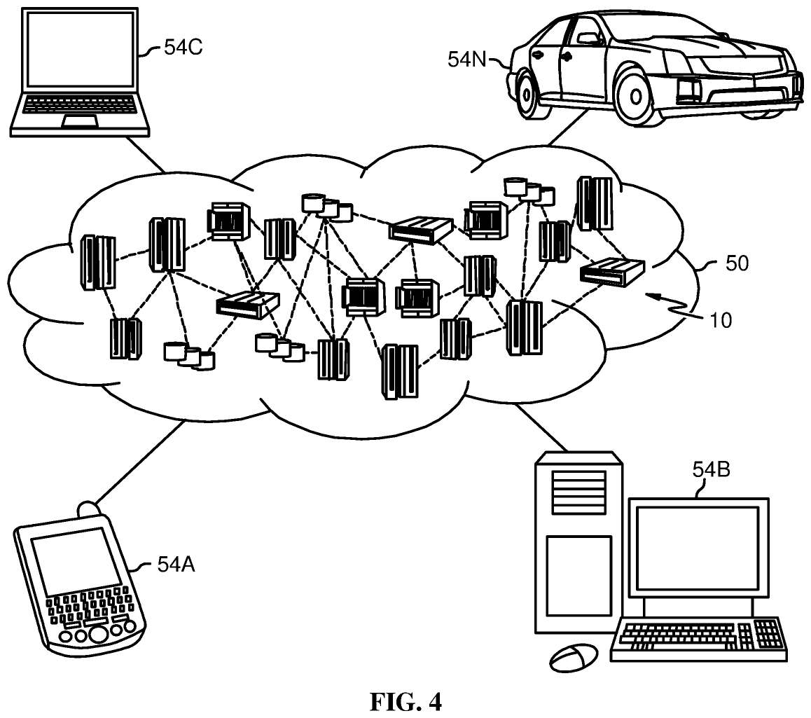

In some embodiments, the network 180 can be one or more computer communication networks, including, for example, a local area network (LAN), or a wide area network (WAN), such as the Internet. In some embodiments, the network 180 can be substantially similar to, or the same as, cloud computing environment 50 described in FIG. 4.

FIG. 2 illustrates a flowchart of an example method 200 for defining clusters of electronic devices among a set of electronic devices and monitoring one or more operating conditions of the clusters of electronic devices. The method 200 can be performed by a condition monitor, such as the condition monitor 140 described with respect to FIG. 1. Referring back to FIG. 2, in step 205, the condition monitor can obtain device data corresponding to a set of electronic devices. Device data can include one or more electrical characteristics of each electronic device. For example, in some embodiments, device data can include an electrical load classification (e.g., whether the effect of an electronic device on a power system is primarily a resistive load, an inductive load, a capacitive load, etc.); a power rating (e.g., an estimate of an amount of power used by the electronic device); and other electrical specifications, such as one or more power factors, harmonics, and/or one or more values of voltage, current, frequency, inductance, capacitance, resistance, and the like, corresponding to the electronic device. In some embodiments, device data can include information such as a location of an electronic device within an environment such as a house and/or a position of an electronic device relative to other electronic devices.

In some embodiments, the condition monitor can obtain device data by user input (e.g., a user manually enters device data into a user interface of the condition monitor). In some embodiments, the condition monitor can obtain device data from a computing device, such as a remote web server that can store and transmit information such as specifications for electronic devices and/or electrical diagrams of buildings. In some embodiments, such as embodiments that include Internet of Things (“IoT”) devices, the condition monitor can obtain device data via network communication with an electronic device.

In step 210, the condition monitor can group a set of electronic devices into a set of clusters based, at least in part, on the device data obtained in step 205. Grouping a set of electronic devices into a set of clusters can include forming, from the set of electronic devices, one or more subsets of one or more electronic devices. For example, TABLE 1 shows a set of five electronic devices grouped into two subsets (i.e., clusters), the first cluster having three electronic devices, and the second cluster having two electronic devices. In some embodiments, the condition monitor can group electronic devices into clusters based, at least in part, on electrical load classifications, relative positions, and/or a sum of the electronics devices' power ratings. An example grouping by a condition monitor is discussed below with regard to TABLE 1.

TABLE 1

| | | | Power Rating | Total |
|---|---|---|---|---|
| Cluster | Device | Classification | (W) | Watts |
| Cluster 1 | Television | Capacitive | 200 | 4200 |
| | Electric stove | Inductive | 2000 | |
| | Water heater | Resistive | 2000 | |
| Cluster 2 | Microwave | Capacitive | 1100 | 1200 |
| | Ceiling fan | Inductive | 100 | |

TABLE 1 lists five electronic devices grouped into two clusters by a condition monitor. For each device, TABLE 1 also lists an electrical load classification and a power rating. For each of the two clusters (i.e., Cluster 1 and Cluster 2), TABLE 1 lists the sum of the power ratings (i.e., Total Watts) for the electronic devices in each cluster. In this example, the condition monitor may have included the television, electric stove, and water heater in Cluster 1 to reduce the number of electronic devices in the cluster having the same electrical load classification (e.g., the condition monitor formed Cluster 1 such that it included only one electronic device having a capacitive classification instead of including two electronic devices having capacitive classifications). Reducing the number of electronic devices in a cluster having the same electrical load classification can facilitate distinguishing electronic signatures between the electronic devices (e.g., an electronic signature of an electronic device having a capacitive classification can have a different phase angle than an electronic signature of an electronic device having an inductive classification). Accordingly, reducing the number of electronic devices in a cluster having the same electrical load classification can facilitate identifying an electronic device producing an electronic signature that indicates a defective operating condition.

Similarly, in the TABLE 1 example, the condition monitor may have included the microwave and the ceiling fan in Cluster 2 because of the relatively large difference (e.g., greater than 150% difference) between the power rating of the microwave (1000 W) and the power rating of the ceiling fan (100 W). The relatively large difference in power ratings can facilitate distinguishing electronic signatures between the microwave and the ceiling fan. Further in this example, the condition monitor may have grouped the electronic devices as shown in TABLE 1 after determining that the sum of the power ratings of the electronic devices in each cluster (i.e., the Total Watts for each cluster) did not exceed a threshold, e.g., 4200 Watts. In some embodiments, such a threshold can be a maximum value measurable by a sensor, which sensor can be used to monitor the operating condition of the electronic devices in the cluster.

Additionally, in some embodiments, the condition monitor can group electronic devices into a cluster based, at least in part, on a relative position of an electronic device (e.g., a position of a first electronic device relative to a position of a second electronic device). By accounting for such relative positions when forming clusters, the condition monitor can form clusters having electronic devices within a threshold measurement range of a sensor. For example, in some embodiments, a sensor used to monitor the electronic devices in a cluster may experience a loss of measurement integrity when a threshold measurement distance between the sensor and an electronic device is exceeded. In such embodiments, the condition monitor can form clusters such that each of the electronic devices included in the cluster can have a position within a threshold measurement distance of a sensor assigned to the cluster.

By grouping the set of electronic devices into a set of clusters, the condition monitor can monitor the electronic devices with a number of sensors that is less than the number of electronic devices (e.g., the five electronic devices shown in TABLE 1 can be monitored with a first sensor corresponding to Cluster 1 and a second sensor corresponding to Cluster 2, as opposed to five sensors corresponding to each of the five electronic devices). Additionally, by monitoring the set of electronic devices with more than one sensor, the condition monitor can accurately determine an operating condition of each electronic device, as discussed in more detail below.

In step 215, the condition monitor can obtain signature data corresponding to one or more electronic devices of each cluster formed in step 210. Signature data can include a set of electrical parameters that correspond to an operating condition of one or more electronic devices in a cluster. For example, electrical parameters can include electrical waveforms (e.g., plots of voltage, current, and/or power variations over time), phasor diagrams, values of power factors, harmonics, voltage, current, frequency, inductance, capacitance, resistance, and the like. An operating condition can indicate how an electronic device is functioning. For example, in some embodiments, an electronic device can have a standard operating condition (e.g., the electronic device functions in accordance with its design specifications without fault or defect), and in some embodiments, an electronic device can have a defective operating condition (e.g., the electronic device is inoperable or the electronic device functions inconsistently with its design specifications, such as with a fault or defect). For example, in some embodiments, a television can have a standard operating condition when the refresh rate of its display and the power it uses to operate are within the design specifications of the television. In contrast, a washing machine can have a defective operating condition when it leaks or overheats.

The condition monitor can obtain signature data from one or more sources. For example, in some embodiments, the condition monitor can obtain signature data from a storage location, such as a memory of a computing device (e.g., a remote Web server). In some embodiments, the signature data can be provided to the condition monitor by an entity such as a device manufacturer and/or a third-party entity that performs tests and/or acquires performance data on electronic devices. Such entities can correlate one or more operating conditions (e.g., one or more standard operating conditions and/or one or more defective operating conditions) of an electronic device with a set of electrical parameters.

In some embodiments, the condition monitor can obtain signature data by generating the signature data. For example, the condition monitor can use simulation tools (e.g., simulation software) to simulate operations of one or more electronic devices. From such simulations, the condition monitor can generate electrical parameters that correspond to one or more operating conditions of the one or more electronic devices. Such simulations can be based, at least in part, on device data, such as the device data obtained in step 205.

For example, in some embodiments, the condition monitor can obtain device data (e.g., electrical load classification, power rating, operating current, etc.) of a dishwasher and an electric stove; the dishwasher and electric stove can be grouped into a cluster. Continuing with this example, using simulation tools, the condition monitor can generate a set of voltage, current, and power waveforms for the dishwasher and the electric stove. Further in this example, the condition monitor can apply a Fourier transform to such waveforms to identify harmonics values for the dishwasher and the electric stove. The generated waveforms and harmonics values can correspond to the dishwasher and the electric stove under standard operating conditions; thus, the generated waveforms and harmonics values can be signature data for the dishwasher and the electric stove under standard operating conditions. Additionally, the condition monitor in this example can combine the signature data of the dishwasher with the signature data of the electric stove to generate composite signature data of the cluster (i.e., the dishwasher and the electric stove) operating on the same electrical circuit. In some embodiments, a simulation performed by the condition monitor can include generating signature data corresponding to one or more defective operating conditions of one or more electronic devices.

In step 220, the condition monitor can determine whether the signature data corresponding to electronic devices is unique. Signature data can be unique when one or more electrical parameters of the signature data do not match. Electrical parameters can match when the values and/or characteristics are identical (or within a threshold range). For example, the condition monitor can determine the signature data matches when the parameter values are within a predetermined range, e.g., 1%-2% of each other. TABLE 2 below includes example signature data for four electronic devices.

TABLE 2

| | | | | Phase |
|---|---|---|---|---|
| Cluster | Device | Classification | Harmonics | angle |
| Cluster 1 | Ceiling fan | Inductive | Fifth order | −15 |
| | Electric stove | Inductive | Seventh order | −30 |
| | Microwave | Capacitive | Seventh order | 60 |
| | Television | Capacitive | Fifth order | 22.5 |

TABLE 2 shows a cluster (Cluster 1) that includes two inductive-load devices (i.e., ceiling fan and electric stove) and two capacitive-load devices (i.e., microwave and television), together with corresponding harmonics and phase angles (i.e., signature data) for each device. The signature data shown in TABLE 2 can correspond to a standard operating condition of each of the Cluster 1 devices. Further in this example, the condition monitor can compare the signature data of the ceiling fan to the signature data of the electric stove. Continuing with this example, the condition monitor can determine that the signature data of the ceiling fan and the signature data of the electric stove are unique because the electronic devices exhibit harmonics that do not match. Further, when comparing the signature data of the ceiling fan to the signature data of the television, the condition monitor can determine that the signature data of those electronic devices are unique because their phase angles indicate quadrants that do not match (i.e., the phase angle of the ceiling fan indicates a fourth quadrant value and the phase angle of the television indicates a first quadrant value). Additionally, the condition monitor can determine that for the standard operating condition of each of the Cluster 1 devices, the corresponding signature data is unique. The condition monitor can make such a determination because each of the Cluster 1 devices has one or more electrical parameters that do not match the electrical parameters of each of the other Cluster 1 devices. For example, the ceiling fan has at least one electrical parameter that does not match the electrical parameters of the electric stove, the ceiling fan has at least one electrical parameter that does not match the electrical parameters of the microwave, and the ceiling fan has at least one electrical parameter that does not match the electrical parameters of the television. Further, the electric stove has at least one electrical parameter that does not match the electrical parameters of the microwave, and at least one electrical parameter that does not match the electrical parameters of the television, and so on.

Continuing with this example, the condition monitor can obtain additional signature data for Cluster 1, shown in TABLE 3 below.

TABLE 3

| | | | | Phase |
|---|---|---|---|---|
| Cluster | Device | Classification | Harmonics | angle |
| Cluster 1 | Ceiling fan | Inductive | Seventh order | −15 |
| | Electric stove | Inductive | Seventh order | −30 |
| | Microwave | Capacitive | Seventh order | 60 |
| | Television | Capacitive | Fifth order | 22.5 |

TABLE 3 shows the signature data for each of the Cluster 1 devices when the ceiling fan has a defective operating condition (e.g., excessive vibration). In this example, the ceiling fan exhibits a seventh-order harmonic, as opposed to a fifth-order harmonic, when it has a defective operating condition. Continuing with this example, the condition monitor can compare the signature data of the ceiling fan to the signature data of the electric stove and determine that the electronic devices exhibit harmonics that match (i.e., both the ceiling fan and the electric stove exhibit seventh-order harmonics). As a result, the condition monitor can determine that for a defective operating condition of the ceiling fan, the corresponding signature data for Cluster 1 is not unique. Additionally, since the condition monitor can determine that signature data corresponding to one operating condition of Cluster 1 (i.e., the signature data corresponding to a defective operating condition of the ceiling fan) is not unique, the condition monitor can proceed back to step 210 to re-group the electronic devices (e.g., remove the ceiling fan from Cluster 1 and add it to a separate cluster, e.g., a Cluster 2). Re-grouping a set of electronic devices can include rearranging one or more electronic devices between clusters (e.g., removing one or more electronic devices from one cluster and adding the one or more electronic devices to one or more different clusters).

However, if the ceiling fan in this example exhibited a third-order harmonic, instead of a seventh-order harmonic, during its defective operating condition, then the condition monitor could determine that the signature data of the ceiling fan and the signature data of the electric stove did not match. In that case, the condition monitor could determine that the signature data corresponding to both operating conditions (i.e., (1) a standard operating condition of each of the Cluster 1 devices and (2) a defective operating condition of the ceiling fan among the Cluster 1 devices) was unique. Furthermore, in that case, the condition monitor could proceed to step 225.

Although the examples discussed above included two operating conditions (i.e., one standard operating condition and one defective operating condition), embodiments of the present disclosure can include multiple standard operating conditions and/or a plurality of defective operating conditions. For example, in some embodiments, signature data can include electrical parameters that correspond to each of a standard operating condition of a washing machine, a first defective operating condition (overheating) of the washing machine, and a second defective operating condition (stalling) of the washing machine. Such a plurality of operating conditions can facilitate identifying a plurality of operating conditions of electronic devices.

By determining that signature data corresponding to electronic devices is unique, embodiments of the present disclosure can reduce inaccuracies in identifying operating conditions of electronic devices within a cluster. For example, in the example regarding TABLE 3 above, the matching seventh-order harmonics of the ceiling fan and the electric stove could present challenges to distinguishing the effect of the ceiling fan and the effect of the electric stove on an electrical waveform measured by a sensor. However, if the signature data in TABLE 3 were unique, then in some embodiments, the electrical parameters measured by a sensor for the ceiling fan and the electric stove could be readily distinguished.

In step 225, the condition monitor can assign sensors to the clusters formed in step 210. In some embodiments, assigning a sensor to a cluster can include the condition monitor designating a sensor to obtain sensor data from a cluster. Sensor data can include electrical parameters (e.g., electrical waveforms and values of power factors, harmonics, voltage, current, frequency, inductance, capacitance, resistance, and the like) corresponding to the electronic devices in a cluster.

In some embodiments, step 225 can include the condition monitor determining, based at least in part on device data obtained in step 205, a placement location for a sensor assigned to a cluster. For example, in some embodiments, in step 225, the condition monitor can obtain operating specifications of a sensor (e.g., a maximum measurement range of 10 meters (m)). Continuing with this example, the device data obtained by the condition monitor in step 205 can indicate that two electronic devices included a cluster are 20 m apart. Continuing with this example, the condition monitor can determine a placement location for the sensor (e.g., a location that is halfway between the two electronic devices) so that the sensor does not exceed its maximum measurement range from either of the two electronic devices. Accordingly, in some embodiments, by determining a placement location for a sensor assigned to a cluster, the condition monitor can reduce potential inaccuracies in the data acquired by a sensor.

In some embodiments, because the condition monitor can form clusters based, at least in part, on both device data and signature data, the number of clusters formed by the condition monitor can indicate a minimum number of sensors that can be sufficient to monitor the clusters. For example, in embodiments in which the condition monitor forms eight clusters and determines that each of the eight clusters has unique signature data, eight sensors can be used to monitor, respectively, the eight clusters.

In some embodiments, method 200 can end after step 225. In these embodiments, step 225 can include the condition monitor transmitting information about the clusters formed in step 210 to a separate entity, and the separate entity can utilize the information to assign sensors to the clusters. For example, in some embodiments, the condition monitor can form five clusters and determine that the five clusters have unique signature data. Continuing with this example, the condition monitor can transmit information that identifies the electronic devices included in each of the five clusters to a third-party (e.g., the condition monitor can transmit a list of the five clusters to a computing device of an end user). Continuing with this example, the third-party can utilize the information to assign one or more sensors to each of the five clusters.

In some embodiments, in step 230, the condition monitor can obtain sensor data for each cluster. Sensor data can include electrical parameters (e.g., electrical waveforms and values of power factors, harmonics, voltage, current, frequency, inductance, capacitance, resistance, and the like) corresponding to the electronic devices in a cluster. In some embodiments, the condition monitor can obtain sensor data corresponding to a cluster from a sensor that is in communication with the electronic devices in the cluster. For example, in some embodiments, a sensor can be connected to a circuit that includes the electronic devices in the cluster, and the sensor can measure electrical parameters from the circuit. In some embodiments, the condition monitor can obtain sensor data intermittently, and in some embodiments the condition monitor can obtain sensor data continuously.

In some embodiments, in step 235, the condition monitor can compare sensor data to signature data. The comparison can include comparing one or more electrical parameters corresponding to one or more electronic devices in a cluster.

In some embodiments, in step 240, the condition monitor can determine whether there is a match between the sensor data and signature data that corresponds to a defective operating condition. If the condition monitor determines in step 240 that there is no such match indicating a defective operating condition (e.g., the condition monitor determines there is a match between the sensor data and signature data that corresponds to a standard operating condition), then the condition monitor can proceed to step 250 and generate a corresponding notification (e.g., the condition monitor can transmit or display a message indicating that the electronic devices in the cluster have a standard operating condition). In some embodiments, the condition monitor can then proceed back to step 230 to obtain additional sensor data for comparison.

If the condition monitor determines in step 240 that there is a match between the sensor data and signature data that corresponds to a defective operating condition, then the condition monitor can proceed to step 245 and generate and/or transmit a corresponding notification (e.g., the condition monitor can transmit or display a message indicating that one or more of the electronic devices in the cluster have a defective operating condition). An example is discussed below with respect to TABLE 4.

TABLE 4

| | | | | Phase |
|---|---|---|---|---|
| Cluster 1 | Device | Classification | Harmonics | angle |
| | Ceiling fan | Inductive | Fifth order | −15 |
| FAULT- | Electric stove | Inductive | [Third order] | −30 |
| overheating | | | | |
| | Microwave | Capacitive | Seventh order | 60 |
| | Television | Capacitive | Fifth order | 22.5 |

TABLE 4 shows example signature data that corresponds to a defective operating condition of an electric stove. Such signature data can be obtained by the condition monitor and stored in a memory of the condition monitor. In this example, the set of brackets around the third-order harmonics entry for the electric stove can indicate that the presence of such third order harmonics in sensor data corresponds to an electric stove that is overheating.

The following is an example in which the condition monitor can generate and/or transmit a notification that corresponds to a defective operating condition, based on TABLE 4. In step 230, the condition monitor can obtain sensor data for Cluster 1, and in step 235, the condition monitor can compare the sensor data to the signature data shown in TABLE 4. In step 240, the condition monitor can determine that the sensor data for Cluster 1 includes a third order harmonic that corresponds to a −30° phase angle. In response, in step 245, the condition monitor can generate and/or transmit a text notification to a mobile device of a user indicating that the electric stove in Cluster 1 is overheating.

FIG. 3 depicts the representative major components of an exemplary Computer System 301 that can be used in accordance with embodiments of the present disclosure. The particular components depicted are presented for the purpose of example only and are not necessarily the only such variations. The Computer System 301 can comprise a Processor 310, Memory 320, an Input/Output Interface (also referred to herein as I/O or I/O Interface) 330, and a Main Bus 340. The Main Bus 340 can provide communication pathways for the other components of the Computer System 301. In some embodiments, the Main Bus 340 can connect to other components such as a specialized digital signal processor (not depicted).

The Processor 310 of the Computer System 301 can be comprised of one or more CPUs 312. The Processor 310 can additionally be comprised of one or more memory buffers or caches (not depicted) that provide temporary storage of instructions and data for the CPU 312. The CPU 312 can perform instructions on input provided from the caches or from the Memory 320 and output the result to caches or the Memory 320. The CPU 312 can be comprised of one or more circuits configured to perform one or more methods consistent with embodiments of the present disclosure. In some embodiments, the Computer System 301 can contain multiple Processors 310 typical of a relatively large system. In other embodiments, however, the Computer System 301 can be a single processor with a singular CPU 312.

The Memory 320 of the Computer System 301 can be comprised of a Memory Controller 322 and one or more memory modules for temporarily or permanently storing data (not depicted). In some embodiments, the Memory 320 can comprise a random-access semiconductor memory, storage device, or storage medium (either volatile or non-volatile) for storing data and programs. The Memory Controller 322 can communicate with the Processor 310, facilitating storage and retrieval of information in the memory modules. The Memory Controller 322 can communicate with the I/O Interface 330, facilitating storage and retrieval of input or output in the memory modules. In some embodiments, the memory modules can be dual in-line memory modules.

The I/O Interface 330 can comprise an I/O Bus 350, a Terminal Interface 352, a Storage Interface 354, an I/O Device Interface 356, and a Network Interface 358. The I/O Interface 330 can connect the Main Bus 340 to the I/O Bus 350. The I/O Interface 330 can direct instructions and data from the Processor 310 and Memory 320 to the various interfaces of the I/O Bus 350. The I/O Interface 330 can also direct instructions and data from the various interfaces of the I/O Bus 350 to the Processor 310 and Memory 320. The various interfaces can comprise the Terminal Interface 352, the Storage Interface 354, the I/O Device Interface 356, and the Network Interface 358. In some embodiments, the various interfaces can comprise a subset of the aforementioned interfaces (e.g., an embedded computer system in an industrial application may not include the Terminal Interface 352 and the Storage Interface 354).

Logic modules throughout the Computer System 301—including but not limited to the Memory 320, the Processor 310, and the I/O Interface 330—can communicate failures and changes to one or more components to a hypervisor or operating system (not depicted). The hypervisor or the operating system can allocate the various resources available in the Computer System 301 and track the location of data in Memory 320 and of processes assigned to various CPUs 312. In embodiments that combine or rearrange elements, aspects of the logic modules' capabilities can be combined or redistributed. These variations would be apparent to one skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

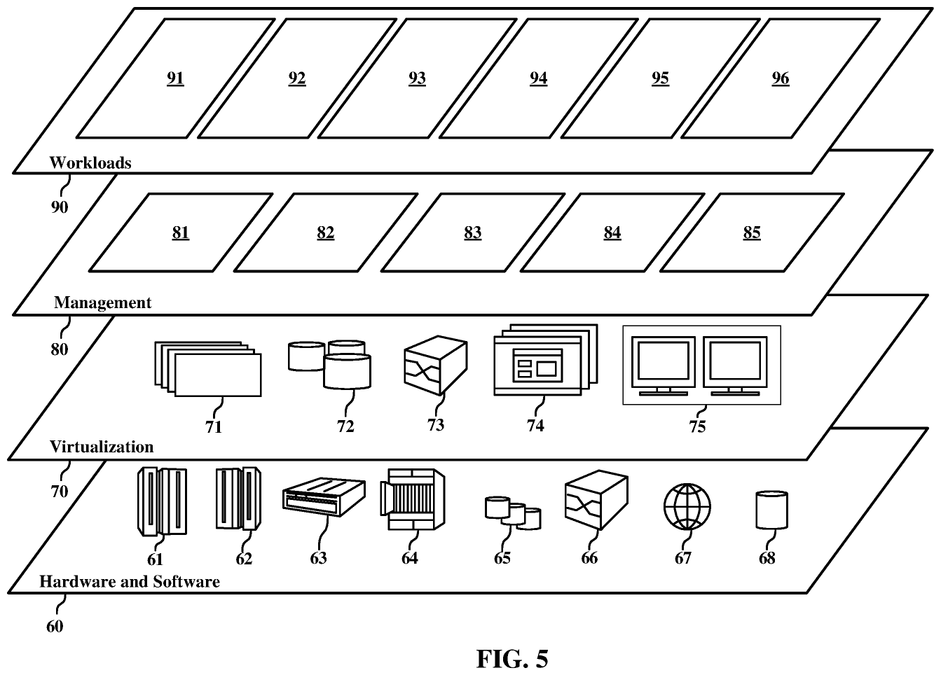

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and condition monitoring logic 96.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining device data corresponding to a set of electronic devices, the set of electronic devices including a first electronic device, a second electronic device, and a third electronic device;
grouping, based on the device data, the set of electronic devices into a first cluster and a second cluster,
wherein the first cluster includes both the first electronic device and the second electronic device, and
wherein the second cluster includes the third electronic device;
obtaining first signature data comprising one or more first electrical parameters of the first electronic device;
obtaining second signature data comprising one or more second electrical parameters of the second electronic device;
making a first determination, based on comparing the first signature data to the second signature data, that a first electrical parameter of the first signature data matches a second electrical parameter of the second signature data;
re-grouping, based on the first determination, the set of electronic devices such that the first cluster includes the first electronic device and the second cluster includes both the second electronic device and the third electronic device;
assigning a first sensor to the first cluster; and
assigning a second sensor to the second cluster.

2. The computer-implemented method of claim 1, wherein the device data includes a first power rating corresponding to the first electronic device and a second power rating corresponding to the second electronic device; and
wherein grouping the first electronic device and the second electronic device into the first cluster includes determining that a sum of the first power rating and the second power rating does not exceed a threshold.

3. The computer-implemented method of claim 1, wherein the device data includes a first electrical load classification and a second electrical load classification;
wherein the first device and the second device have the first electrical load classification;
wherein the third device has the second electrical load classification; and
wherein the first electrical load classification and the second electrical load classification do not match.

4. The computer-implemented method of claim 1, wherein the device data includes a first distance between the second device and the third device.

5. The computer-implemented method of claim 4, wherein assigning the second sensor to the second cluster includes determining based, at least in part, on the first distance, a placement location for the second sensor.

6. The computer-implemented method of claim 1, further comprising:
obtaining third signature data comprising one or more third electrical parameters of the third electronic device; and
making a second determination that a third electrical parameter of the third signature data does not match the second electrical parameter.

7. The computer-implemented method of claim 1, further comprising:
obtaining, by the second sensor, sensor data corresponding to the second electronic device;
comparing the sensor data to the second signature data;
making a third determination, based on the comparing, that the sensor data corresponds to a defective operating condition of the second electronic device; and
generating a notification in response to the third determination.

8. A system comprising:
a processor; and
a memory in communication with the processor, the memory containing program instructions that, when executed by the processor, are configured to cause the processor to perform a method, the method comprising:
obtaining device data corresponding to a set of electronic devices, the set of electronic devices including a first electronic device, a second electronic device, and a third electronic device;
grouping, based on the device data, the set of electronic devices into a first cluster and a second cluster,
wherein the first cluster includes both the first electronic device and the second electronic device, and
wherein the second cluster includes the third electronic device;
obtaining first signature data comprising one or more first electrical parameters of the first electronic device;
obtaining second signature data comprising one or more second electrical parameters of the second electronic device;
making a first determination, based on comparing the first signature data to the second signature data, that a first electrical parameter of the first signature data matches a second electrical parameter of the second signature data;
re-grouping, based on the first determination, the set of electronic devices such that the first cluster includes the first electronic device and the second cluster includes both the second electronic device and the third electronic device;
assigning a first sensor to the first cluster; and
assigning a second sensor to the second cluster.

9. The system of claim 8, wherein the device data includes a first power rating corresponding to the first electronic device and a second power rating corresponding to the second electronic device; and
wherein grouping the first electronic device and the second electronic device into the first cluster includes determining that a sum of the first power rating and the second power rating does not exceed a threshold.

10. The system of claim 8, wherein the device data includes a first electrical load classification and a second electrical load classification;
wherein the first device and the second device have the first electrical load classification;
wherein the third device has the second electrical load classification; and
wherein the first electrical load classification and the second electrical load classification do not match.

11. The system of claim 8, wherein the device data includes a first distance between the second device and the third device.

12. The system of claim 11, wherein assigning the second sensor to the second cluster includes determining based, at least in part, on the first distance, a placement location for the second sensor.

13. The system of claim 8, further comprising:
obtaining third signature data comprising one or more third electrical parameters of the third electronic device; and
making a second determination that a third electrical parameter of the third signature data does not match the second electrical parameter.

14. The system of claim 8, further comprising:
obtaining, by the second sensor, sensor data corresponding to the second electronic device;
comparing the sensor data to the second signature data;
making a third determination, based on the comparing, that the sensor data corresponds to a defective operating condition of the second electronic device; and
generating a notification in response to the third determination.

15. A computer program product comprising a computer readable storage medium having program instructions embodied therewith, wherein the computer readable storage medium is not a transitory signal per se, the program instructions executable by a processor to cause the processor to perform a method, the method comprising:
obtaining device data corresponding to a set of electronic devices, the set of electronic devices including a first electronic device, a second electronic device, and a third electronic device;
grouping, based on the device data, the set of electronic devices into a first cluster and a second cluster,
wherein the first cluster includes both the first electronic device and the second electronic device, and
wherein the second cluster includes the third electronic device;
obtaining first signature data comprising one or more first electrical parameters of the first electronic device;
obtaining second signature data comprising one or more second electrical parameters of the second electronic device;
making a first determination, based on comparing the first signature data to the second signature data, that a first electrical parameter of the first signature data matches a second electrical parameter of the second signature data;
re-grouping, based on the first determination, the set of electronic devices such that the first cluster includes the first electronic device and the second cluster includes both the second electronic device and the third electronic device;
assigning a first sensor to the first cluster; and
assigning a second sensor to the second cluster.

16. The computer program product of claim 15, wherein the device data includes a first power rating corresponding to the first electronic device and a second power rating corresponding to the second electronic device; and
wherein grouping the first electronic device and the second electronic device into the first cluster includes determining that a sum of the first power rating and the second power rating does not exceed a threshold.

17. The computer program product of claim 15, wherein the device data includes a first electrical load classification and a second electrical load classification;
wherein the first device and the second device have the first electrical load classification;
wherein the third device has the second electrical load classification; and
wherein the first electrical load classification and the second electrical load classification do not match.

18. The computer program product of claim 15, wherein the device data includes a first distance between the second device and the third device.

19. The computer program product of claim 18, wherein assigning the second sensor to the second cluster includes determining based, at least in part, on the first distance, a placement location for the second sensor.

20. The computer program product of claim 15, further comprising:
obtaining third signature data comprising one or more third electrical parameters of the third electronic device; and
making a second determination that a third electrical parameter of the third signature data does not match the second electrical parameter.
